(19) United States
(12) Patent Application Publication
(10) Pub. No.: US 2013/0278397 A1
(43) Pub. Date: Oct. 24, 2013

(54) REMOTE CONTROL METHOD AND SYSTEM AND MOBILE DEVICE OF THE SYSTEM

(71) Applicant: HON HAI PRECISION INDUSTRY CO., LTD., New Taipei (TW)

(72) Inventors: DENG-RUNG LIU, New Taipei (TW); I-CHIH CHEN, New Taipei (TW)

(73) Assignee: HON HAI PRECISION INDUSTRY CO., LTD., New Taipei (TW)

(21) Appl. No.: 13/864,288

(22) Filed: Apr. 17, 2013

(30) Foreign Application Priority Data
Apr. 20, 2012 (TW) 101114060

(51) Int. Cl. G08C 17/02

(52) U.S. Cl. CPC G08C 17/02
USPC 340/12.5

(57) ABSTRACT

A remote control method applied in a mobile device whereby movements of the mobile device are detected via an acceleration sensor internally installed in the mobile device. An acceleration generated according to the movement is determined as being smaller or greater than a predetermined threshold value. If the acceleration is equal to or greater than the predetermined threshold value, a control instruction is generated. The control instruction is transmitted to an electronic device via a wireless network module of the mobile device to trigger a preset switch operation between the mobile device and the electronic device.

### BACKGROUND

1. Technical Field

The present disclosure relates to mobile communications, and more particularly to a remote control method and system, and a mobile device employed in the system.

2. Description of Related Art

An electronic device such as a loudspeaker, a television, a set-top box, a digital camera, an electric fan or an air conditioner is often provided with a remote control. A typical remote control is provided with multiple buttons to implement multi-functional operations according to a user's input.

However, when a remote control has too many buttons, it tends to confuse users, such that some users prefer to execute only basic control functions of the remote control rather than useful and advanced control functions.

Nowadays smart phones are widely used. More and more remote control applications available in smart phones are able to simulate user interfaces of conventional remote controls, to simplify users' control operations. Most user interfaces of such remote control applications simply present the layout of a conventional remote control. As a result, the problem of user confusion exists in smart phones too.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the views.

FIG. 1 is a block diagram of an exemplary embodiment of a remote control system in accordance with the present disclosure.

FIG. 2 is a block diagram of detailed structure of an exemplary embodiment of the remote control system in accordance with the present disclosure.

FIG. 3 is a flowchart of an exemplary embodiment of a remote control method in accordance with the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

An exemplary embodiment of a remote control method and system of the present disclosure differentiates and identifies the actions or behavior of a user according to the user's movements of a mobile device. Thus, a user can easily and intuitively achieve remote control and management of electronic devices, such as set-top boxes and smart televisions, via the mobile device.

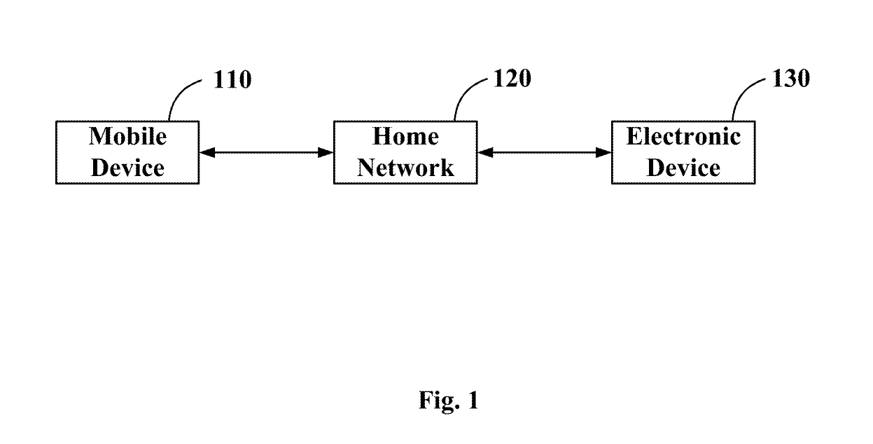

Referring to FIG. 1, an exemplary embodiment of a remote control system 10 of the present disclosure includes a mobile device 110, a home network 120 and an electronic device 130. The mobile device 110 can be a smart phone, a tablet computer, or another kind of mobile device which is capable of running mobile applications (APPs). The home network 120 is a hardwired network or a network applicable to wireless transmission protocols. The electronic device 130 can be a smart TV, a set-top box, or other smart device.

The mobile device 110 controls the electronic device 130 via the home network 120. In the present embodiment, when the mobile device 110 is moved by a user gesture, for example, swinging the mobile device 110, an acceleration signal (hereinafter a gesture input signal 70) is generated. The acceleration signal instructs that current playing of multimedia content on the mobile device 110 be switched to the electronic device 130, or that current playing of multimedia content on the electronic device 130 be switched to the mobile device 110.

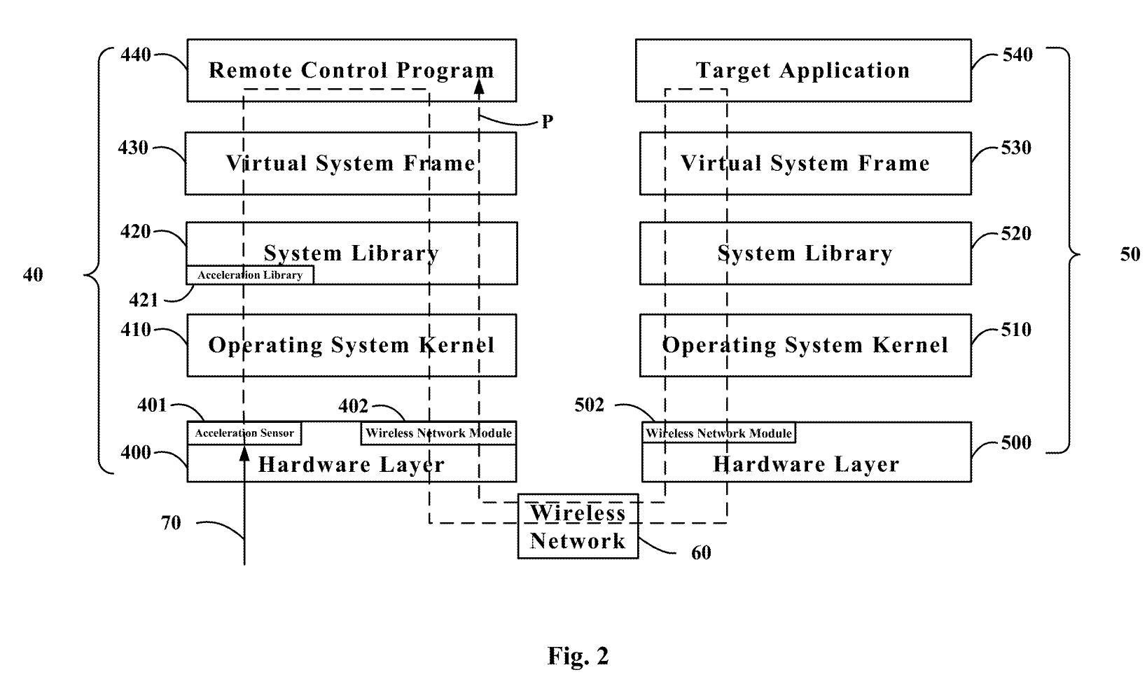

Referring also to FIG. 2, in the following description, a mobile device 40 is provided as an example of the mobile device 110, and a smart TV 50 is provided as an example of the electronic device 130. Software and hardware units of the mobile device 40 include a hardware layer 400, an operating system kernel 410, a system library 420, a virtual system frame 430, and a remote control program 440. The hardware layer 400 includes an acceleration sensor 401 and a wireless network module 402.

The operating system kernel 410 is Linux™ or any one of other operating system kernels such as Windows™, Mac OS™ or iOS™. The wireless network module 402 is a wireless network device compatible to the Institute of Electrical and Electronics Engineers (IEEE) 802.11 standard or any one of other wireless communication standards such as Bluetooth™ or Zigbee™.

Software and hardware units of the smart TV 50 include a hardware layer 500, an operating system kernel 510, a system library 520, a virtual system frame 530, and a target application 540. The hardware layer 500 further includes a wireless network module 502.

The operating system kernel 510 is Linux™ or any one of other operating system kernels such as Windows™, Mac OS™ or iOS™. The wireless network module 502 is a wireless network device compatible to the IEEE 802.11 standard or any one of other wireless communication standards such as Bluetooth™ or Zigbee™

A wireless network 60 is comprised of wireless communication channels and/or network devices interconnecting the mobile device 40 and the smart TV 50. In particular, the wireless network 60 comprises one or more wireless network devices compatible to the IEEE 802.11 standard or any one of other wireless communication standards such as Bluetooth™ or Zigbee™

The mobile device 40 receives a gesture input signal 70 via the acceleration sensor 401 of the hardware layer 400. A processor (not shown) of the mobile device 40 delivers and converts the gesture input signal 70 between the software and hardware units of the mobile device 40 along the sequence indicated by a path P (shown in a broken line in FIG. 2), from the acceleration sensor 401 to the wireless network module 402. The mobile device 40 then transmits, via the wireless network module 402 of the hardware layer 400, a control signal corresponding to the gesture input signal 70 to the smart TV 50 through the wireless network 60.

The smart TV 50 receives the control signal corresponding to the gesture input signal 70 via the wireless network module 502 of the hardware layer 500. A processor (not shown) of the smart TV 50 delivers the control signal between the software and hardware units of the smart TV 50 along the sequence indicated by the path P, from the wireless network module 502 and back to the wireless network module 502. Thus, the mobile device 40 transmits the control signal to the target application 540 via the system library 520. The target application 540 transmits and receives data, for example, setting data related to currently played multimedia contents, according to the control signal.

The delivery and conversion of the gesture input signal 70 along the path P between the software and hardware units of the mobile device 40 (and then to the wireless network 60), as executed by the processor (not shown) of the mobile device 40, is shown in Table 1 as follows:

TABLE 1

| Sequence | Transmitting Unit | Receiving Unit |
|---|---|---|
| 1 | Acceleration Sensor 401 | Operating System |
| | | Kernel 410 |
| 2 | Operating System | Acceleration Library 421 |
| | Kernel 410 | |
| 3 | Acceleration Library 421 | Virtual System Frame 430 |
| 4 | Virtual System Frame 430 | Remote Control Program 440 |
| 5 | Remote Control Program 440 | Virtual System Frame 430 |
| 6 | Virtual System Frame 430 | System Library 420 |
| 7 | System Library 420 | Operating System |
| | | Kernel 410 |
| 8 | Operating System | Wireless Network |
| | Kernel 410 | Module 402 |
| 9 | Wireless Network | Wireless Network 60 |
| | Module 402 | |

The delivery and conversion of the gesture input signal 70 along the path P between the software and hardware units of the smart TV 50 (including from and to the wireless network 60), as executed by the processor (not shown) of the smart TV 50, is shown in Table 2 as follows:

TABLE 2

| Sequence | Transmitting Unit | Receiving Unit |
|---|---|---|
| 1 | Wireless network 60 | Wireless Network |
| | | Module 502 |
| 2 | Wireless Network | Operating System |
| | Module 502 | Kernel 510 |
| 3 | Operating System | System Library 520 |
| | Kernel 510 | |
| 4 | System Library 520 | Virtual System Frame 530 |
| 5 | Virtual System Frame 530 | Target Application 540 |
| 6 | Target Application 540 | Virtual System Frame 530 |
| 7 | Virtual System Frame 530 | System Library 520 |
| 8 | System Library 520 | Operating System |
| | | Kernel 510 |
| 9 | Operating System | Wireless Network |
| | Kernel 510 | Module 502 |
| 10 | Wireless Network | Wireless Network 60 |
| | Module 502 | |

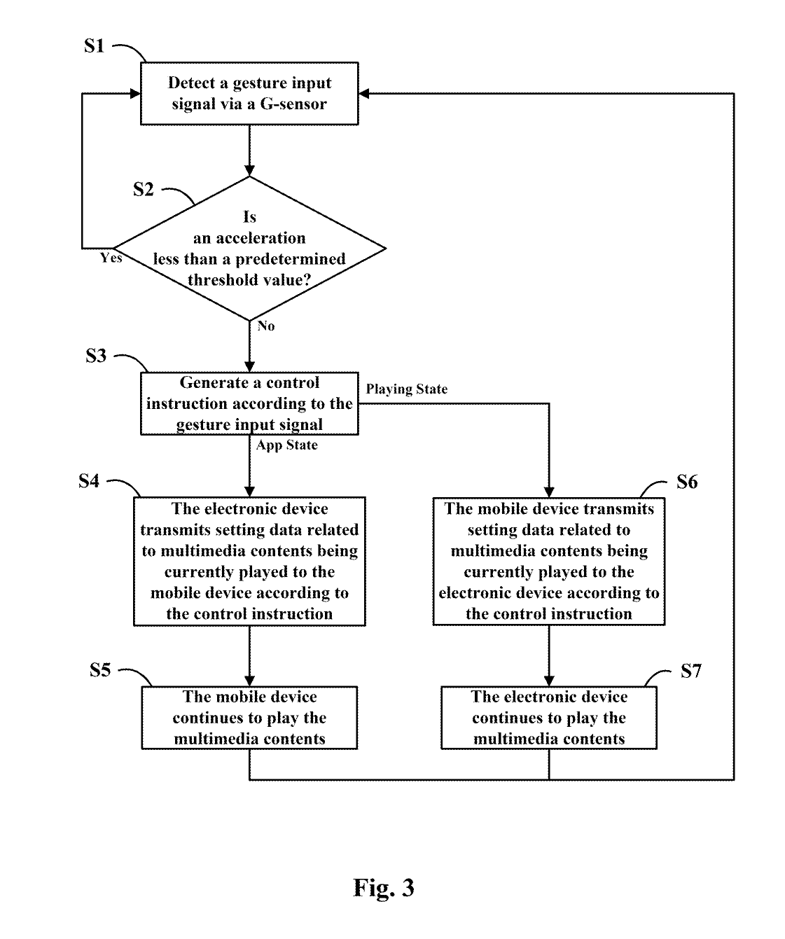

FIG. 3 is a flowchart of an exemplary embodiment of a remote control method in accordance with the present disclosure. The remote control method is applied to a mobile device installed with a G-sensor, e.g., the acceleration sensor 401, for controlling a remote electronic device, such as a set-top box or a smart TV, according to control signals generated by movements of the mobile device.

Prior to the beginning of the remote control method, the mobile device is matched with the electronic device using a search algorithm, such as the M-Search algorithm for example.

In the method, an application of the mobile device detects a movement, such as a swinging of the mobile device, via a G-sensor internally installed in the mobile device (step S1). The application determines whether acceleration resulting from the movement is less than a predetermined threshold value, for example 1.5 g (step S2).

If the acceleration is less than the predetermined threshold value, no consequential signal is generated or only a preset message is transmitted. If the acceleration is equal to or greater than the predetermined threshold value, the application generates a control instruction according to the movement (step S3), and transmits the control instruction to the electronic device via a wireless network module of the mobile device, thereby triggering a preset switch operation between the mobile device and the electronic device. The switch operation means to change or switch devices, whereby control of a playback function of the electronic device is immediately taken over by the mobile device in place of the electronic device, or vice versa.

In detail, when at the time step S3 is performed the mobile device is executing a mobile application, i.e. acting in an operating state (App State), the electronic device transmits setting data related to multimedia contents being currently played on the electronic device to the mobile device according to the control instruction (step S4). The setting data may include a Uniform Resource Locator (URL) address and a playback point of the multimedia contents. When the setting data is obtained, the mobile device activates a multimedia application to take over the playback of the multimedia contents and continue the playback of the multimedia contents (step S5).

When at the time step S3 is performed the mobile device is executing a multimedia application, i.e. acting in a playing state (PLAYING STATE), the mobile device transmits setting data related to multimedia contents being currently played on the mobile device to the electronic device according to the control instruction (step S6). The setting data may include a URL address and a playback point of the multimedia contents. When the setting data is obtained, the electronic device takes over the playback of the multimedia contents to continue the playback of the multimedia contents (step S7).

In summary, exemplary embodiments of a remote control method and system of the present disclosure identify and differentiate control behavior of the user according to movements of a mobile device such as a mobile phone. Thus, users can easily and intuitively achieve remote control and management of electronic devices such as set-top boxes and smart TVs.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A remote control method applied in a mobile device, the method comprising:
detecting a movement of the mobile device via an acceleration sensor internally installed in the mobile device;
determining whether an acceleration generated according to the movement is less than a predetermined threshold value;
generating a control instruction according to the movement if the acceleration is greater than or equal to the predetermined threshold value; and
transmitting the control instruction to an electronic device via a wireless network module of the mobile device, thereby triggering a preset switch operation between the mobile device and the electronic device according to the control instruction.

2. The remote control method of claim 1, wherein the preset switch operation comprises:
transmitting, by the electronic device, setting data related to multimedia contents being currently played on the electronic device to the mobile device according to the control instruction when the mobile device acts in an operating state; and
taking over and continuing, by the mobile device, a playback of the multimedia contents according to the setting data when the mobile device obtains the setting data.

3. The remote control method of claim 2, wherein the setting data comprises a Uniform Resource Locator (URL) address and a playback point of the multimedia contents.

4. The remote control method of claim 1, wherein the preset switch operation comprises:
transmitting, by the mobile device, setting data related to multimedia contents being currently played on the mobile device to the electronic device according to the control instruction when the mobile device acts in a playing state; and
taking over and continuing, by the electronic device, a playback of the multimedia contents according to the setting data when the electronic device obtains the setting data.

5. The remote control method of claim 4, wherein the setting data comprises a Uniform Resource Locator (URL) address and a playback point of the multimedia contents.

6. A remote control system, the system comprising:
an electronic device; and
a mobile device comprising:
an acceleration sensor; and
a wireless network module;
the mobile device configured to detect a movement thereof via the accelerator sensor, determine whether an acceleration generated according to the movement is less than a predetermined threshold value, generate a control instruction according to the movement if the acceleration is greater than or equal to the predetermined threshold value, and transmit the control instruction to the electronic device via the wireless network module, thereby triggering a preset switch operation between the mobile device and the electronic device according to the control instruction.

7. The remote control system of claim 6, wherein:
the electronic device is configured to, in response to the preset switch operation, transmit setting data related to multimedia contents being currently played on the electronic device to the mobile device according to the control instruction when the mobile device acts in an operating state; and
the mobile device is further configured to take over and continue a playback of the multimedia contents according to the setting data when the mobile device obtains the setting data.

8. The remote control system of claim 7, wherein the setting data comprises a Uniform Resource Locator (URL) address and a playback point of the multimedia contents.

9. The remote control system of claim 6, wherein:
the mobile device is further configured to, when the mobile device acts in a playing state, transmit setting data related to multimedia contents being currently played on the mobile device to the electronic device according to the control instruction; and
the electronic device is configured to take over and continue a playback of the multimedia contents according to the setting data when the electronic device obtains the setting data.

10. The remote control system of claim 9, wherein the setting data comprises a Uniform Resource Locator (URL) address and a playback point of the multimedia contents.

11. A mobile device, comprising:
a hardware layer, comprising an acceleration sensor and a wireless network module;
a system library unit, comprising an acceleration library unit; and
a remote control unit configured to detect a movement of the mobile device via the acceleration sensor, determine whether an acceleration generated according to the movement is less than a predetermined threshold value via the acceleration library unit, generate a control instruction according to the movement if the acceleration is greater than or equal to the predetermined threshold value, and transmit the control instruction to a target application installed in an electronic device via the wireless network module, thereby triggering a preset switch operation between the mobile device and the electronic device.

12. The mobile device of claim 11, wherein when the mobile device acts in an operating state and in response to the preset switch operation the target application transmits setting data related to multimedia contents being currently played on the electronic device to the remote control unit according to the control instruction, the remote control unit is further configured to obtain the setting data via the wireless network module and take over and continue a playback of the multimedia contents according to the setting data.

13. The mobile device of claim 12, wherein the setting data comprises a Uniform Resource Locator (URL) address and a playback point of the multimedia contents.

14. The mobile device of claim 11, wherein the remote control unit is further configured to, when the mobile device acts in a playing state, transmit setting data related to multimedia contents being currently played on the mobile device to the target application via the wireless network module according to the control instruction, and the setting data is data that enables the electronic device to take over and continue a playback of the multimedia contents.

15. The mobile device of claim 14, wherein the setting data comprises a Uniform Resource Locator (URL) address and a playback point of the multimedia contents.
